(19) United States
(12) Patent Application Publication
(10) Pub. No.: US 2023/0363372 A1
(43) Pub. Date: Nov. 16, 2023

(54) Mosquito repelling device and related method thereof

(71) Applicant: Isaiah En-Yang Liu, Hsinchu City (TW)

(72) Inventor: Isaiah En-Yang Liu, Hsinchu City (TW)

(21) Appl. No.: 18/358,123

(22) Filed: Jul. 25, 2023

(51) Int. Cl. A01M 29/16; H04R 3/04; H04R 1/02; A01M 29/12

(52) U.S. Cl. CPC A01M 29/16; H04R 3/04; H04R 1/028; A01M 29/12

(57) ABSTRACT

A mosquito repelling device is disclosed. The mosquito repelling device comprises: a microphone, configured to receive surrounding sounds; a power supply, configured to receive power; a first output device, configured to repel mosquitoes; and a processor, configured to process the received surrounding sounds from the microphone, determine whether there are mosquitoes present, and instruct the output device to repel mosquitoes if the processor determines there are mosquitoes present.

### BACKGROUND

Many people like to engage in outdoor activities such as hiking. However, mosquitoes are prevalent in many areas of the world. People with mosquito bites may suffer from skin irritations, allergies and sometimes even contract deadly diseases such as malaria. For people with sensitive skins, wounds from the mosquito bites may also cause bacterial infections. To avoid mosquito bites, some people may spray mosquito repellent on their legs or arms, which may cause skin irritations, and they may need to spray the repellent again before it loses its effect. Others may light mosquito coils, but they would then need to sit at the spot and therefore cannot move around and enjoy the outdoors. As a result, both methods are ineffective and inconvenient, especially for people with sensitive skins who enjoy outdoor activities.

### SUMMARY

One objective of an embodiment of the present disclosure is to provide a mosquito repelling device and a related method thereof to avoid mosquito bites.

According to an embodiment of the present disclosure, a mosquito repelling device is disclosed. The mosquito repelling device comprises: a microphone, configured to receive surrounding sounds; a power supply, configured to receive power; a first output device, configured to repel mosquitoes; and a processor, configured to process the received surrounding sounds from the microphone, determine whether there are mosquitoes present, and instruct the output device to repel mosquitoes if the processor determines there are mosquitoes present.

According to an embodiment of the present disclosure, a method of determining and reacting on a presence of a mosquito is disclosed. The method comprises: utilizing a microphone to receive surrounding sounds; utilizing a filter to filter out frequencies in the surrounding sounds, which are unrelated to the frequencies of female mosquitoes flapping their wings, to generate filtered sounds; utilizing a processor to examine the filter sounds in order to determine the presence of the mosquito; and emitting a mosquitoes repelling item.

### BRIEF DESCRIPTION OF THE DRAWINGS

FIG. 1-1 is a diagram of a mosquito repelling device according to an embodiment of the present disclosure.

FIG. 1-2 is a diagram of a mosquito repelling device according to another embodiment of the present disclosure.

FIG. 1-3 is a diagram of a mosquito repelling device according to another embodiment of the present disclosure.

FIG. 2 is a functional block diagram of a processor according to an embodiment of the present disclosure.

FIG. 3 is a flow chart of a method of determining and reacting on mosquitoes' presence according to an embodiment of the present disclosure.

### DETAILED DESCRIPTION OF PREFERRED EMBODIMENTS

Specifically, the terminologies in the embodiments of the present disclosure are merely for describing the purpose of the certain embodiment, but not to limit the disclosure. Examples and the appended claims be implemented in the present disclosure requires the use of the singular form of the book “an”, “the” and “the” are intended to include most forms unless the context clearly dictates otherwise. It should also be understood that the terminology used herein that “and/or” means and includes any or all possible combinations of one or more of the associated listed items.

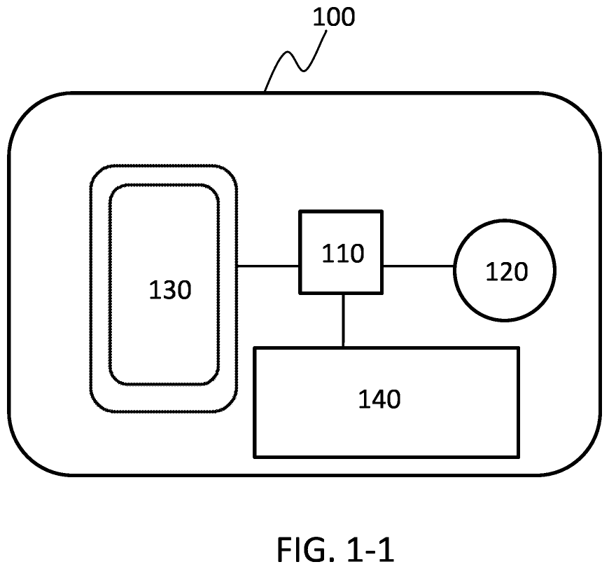

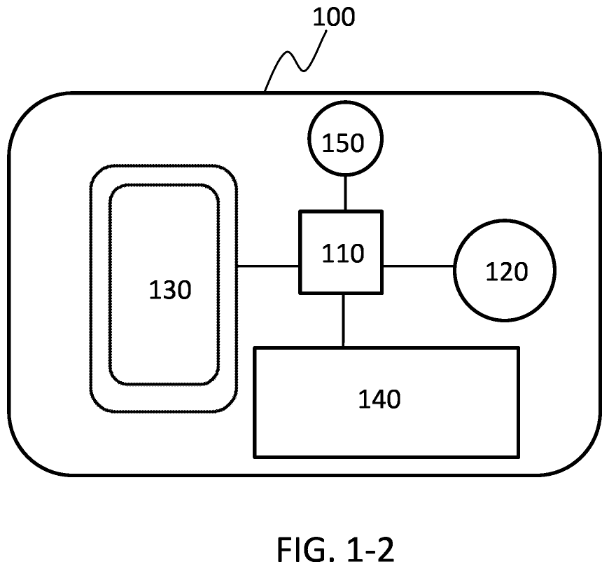

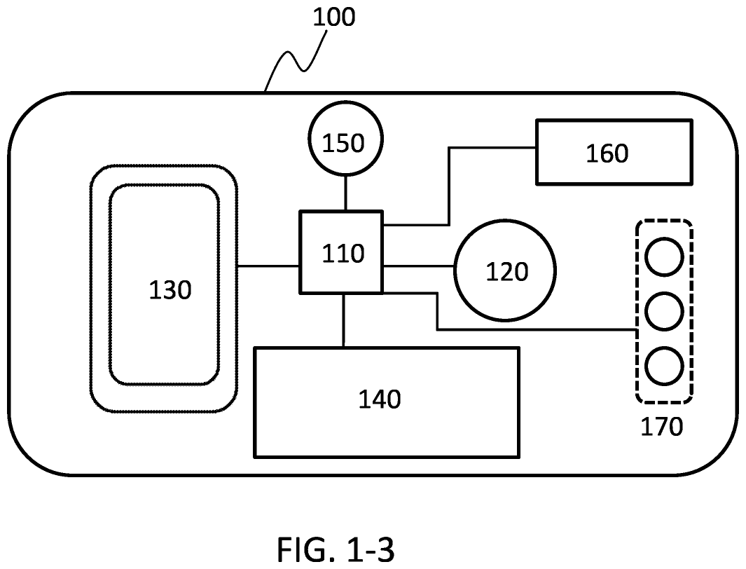

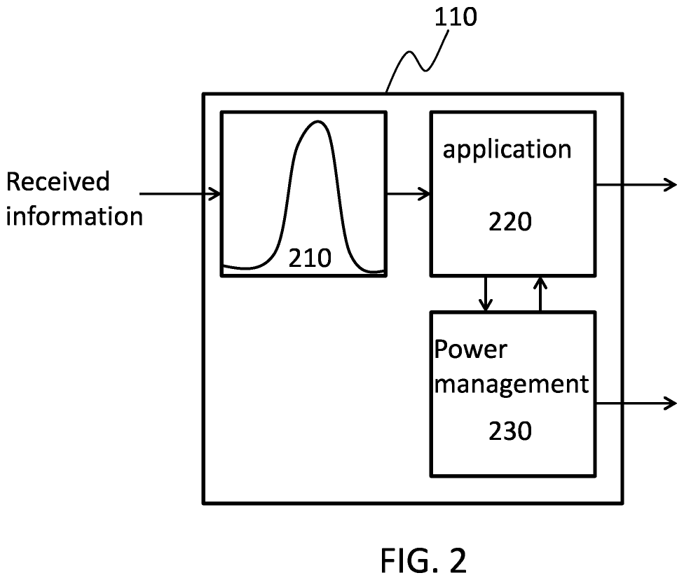

Please refer to FIG. 1-1. FIG. 1-1 illustrates a mosquito repelling device 100 which is portable and especially useful for people who do outdoor activities. The mosquito repelling device 100 has a processor 110, a microphone 120, an output device 130, and a power supply 140. FIG. 1-2 illustrates another embodiment where the mosquito repelling device 100 has an additional output device 150. The mosquito repelling device 100 can receive surrounding sounds through the microphone 120. It is recommended to use a highly sensitive microphone to pick up certain frequencies of sound. According to research, the frequency of female mosquitoes flapping their wings commonly falls between 300 and 600 Hz. Therefore, for the purpose of sensing the presence of mosquitoes, the microphone 120 needs to pick up at least 300 to 600 Hz, then sends the sound signal to the processor 110.

FIG. 2 exemplifies a functional block diagram of the processor 110. The processor 110 has a band-pass filter 210, an application block 220, and a power management block 230. The band-pass filter 210 will receive the sound signal from the microphone 120. The band-pass filter 210 filters out unwanted frequency, such as below 300 Hz and above 600 Hz. The cut-off frequency can be changed based on the mosquito types in that area. The band-pass filter then passes the filtered sound signal to the application block 220 for further processes. The application block 220 then checks whether the filtered sound signal is really the sound of mosquitoes or just noise in many ways. One possible way is letting the application block 220 check if the filtered sound frequency profile meets any of the sound profiles of mosquitoes. For example, several pre-stored mosquito sound profiles can be stored in a memory so the application block 220 can then compare them against the filtered sound profile. Another way is letting the application block 220 checks if the magnitude of the filtered sound signal is greater than a certain threshold for a certain period of time. In this case, setting the threshold of magnitude and time period can effectively avoid misjudgment of background noise or human voice. Please note, designers can put an amplifier to amplify the filtered sound signal. This amplifier can be placed before or after the band-pass filter 210. It is also possible to place an analog to digital converter to convert the sound signal. Such converter can also be placed either before or after the band-pass filter 210. These changes all fall within the scope of the present disclosure.

Once the application block 220 determines that there are mosquitoes present, the application block 220 will send a signal to the power management 230 and the output device 130. A driver, which can be included in the processor 110 or independently included in the mosquito repelling device 100, is configured to drive the output device 130. The output device 130 can be a high pitch sound speaker which can emit high pitch sounds to repel mosquitoes. It is preferable for the output device 130 to emit high pitch sounds ranging from 25 kHz to 30 kHz because this frequency range is capable of repelling mosquitoes but cannot be heard by human. Because it is more effective to repel mosquitoes if the volume of the high pitch sound is higher, it is preferable for the output device 130 to emit higher volume of the high pitch sound. However, high volume sound output will drain the power faster, so the power management block 230 will manage the balance of the power use and the effectiveness of repelling mosquitoes by managing the output device 130's usage of the power from the power supply 140. One way is that the power management block 230 can stop power supply to the output device 130 after a predetermined time period that is enough to repel the mosquitoes. Another possible way is that the power management block 230 can provide a pulse-like power supply to the output device 130 which would further reduce the power usage of the output device 130.

In another embodiment, the output device 130 can be a device emitting chemical vapor that can repel mosquitoes. Because the output device 130 can store only a certain amount of chemical, the output device 130 will only emit chemical vapor once the processor 110 determines there are mosquitoes present and instructs the output device 130 to emit chemical vapor. It is recommended to design the output device 130 with a small container capable of refilling the chemical when it is used up.

In another embodiment, the mosquito repelling device 100 may include a second output device 150 as illustrated in FIG. 1-2. The second output device 150 can be a buzzer. The processor 110 may instruct the buzzer to buzz once the processor 110 determines that there are mosquitoes presented. The processor 110 may also instruct the buzzer to buzz when the processor 110 instructs the output device 130 to emit high pitch sound or to emit chemical vapor. This is for informing the users that the output device 130 is working, but it can be turned off by the user.

In another embodiment, the second output device 150 as illustrated in FIG. 1-2 can be a LED. The processor 110 may turn the LED on or make LED blink when the processor 110 determines that there are mosquitoes present. Other than a simple on and off, there can be many other options for the LED blinking patterns when the processor 110 instructs the output device 130 to emit high pitch sound or to emit chemical vapor.

In another embodiment, the second output device 150, as illustrated in FIG. 1-2, can be a speaker. The processor 110 may instruct the speaker to make a warning sound or to voice something like “Mosquitoes Present!” once the processor 110 determines that there are mosquitoes present. The processor 110 may also instruct the speaker to make a reminding sound or to voice something like “Repelling Mosquitoes!” when the processor 110 instructs the output device 130 to emit high pitch sound or to emit chemical vapor.

In another embodiment, as illustrated in FIG. 1-3, the mosquito repelling device 100 further comprises a display 160 and a control interface 170. The display 160 may show the battery status, whether there are mosquitoes present, or whether the output device 130 is working. The display 160 can also work with the control interface 170 for user to set the mosquito repelling device 100. A user may set his preference, including a normal mode or a power saving mode; whether there will be a warning message by buzzer/speaker or warning light by LED; whether the output devices 130 will emit both high pitch sound and chemical vapor if there are two output devices 130; or each of the two output devices 130 will emit either high pitch sound or chemical vapor.

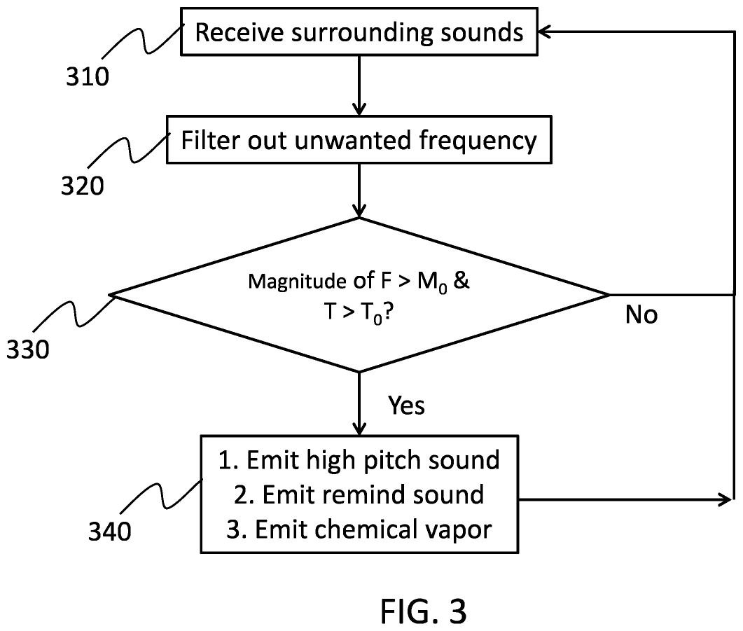

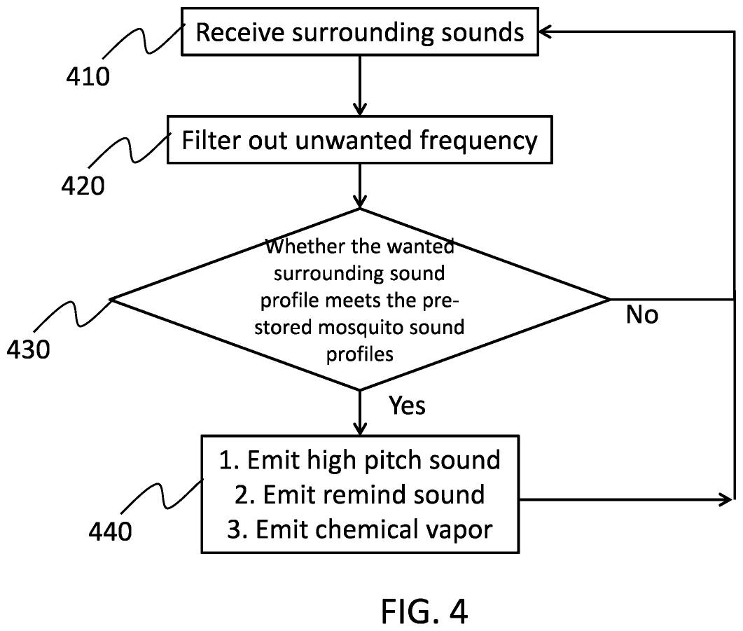

FIG. 3 shows an exemplary method of determining and reacting on mosquitoes' presence. In step 310, utilizing a microphone to receive surrounding sounds. In step 320, utilizing a filter to filter out unwanted frequency of the received surrounding sounds, which are unrelated to the frequencies of female mosquitoes flapping their wings, to generate filtered sounds. For example, the filter may filter out frequency below 300 Hz and frequency above 600 Hz of the received surrounding sounds, and only frequency between 300 Hz and 600 Hz of the surrounding sounds will be kept (wanted surrounding sound). Please note, the cut-off frequencies, 300 Hz and 600 Hz, may vary from area to area which depend on the frequency generated by certain kind of mosquitoes in that area. In step 330, utilizing a processor to examine whether a magnitude of the filtered sounds is greater than a set magnitude Mo and lasts longer than a set period To. If the magnitude of the filtered sounds is not greater than Mo or does not last longer than To, it will go back to step 310 and starts to receive surrounding sound again. However, if the magnitude of the filtered sound is greater than Mo and lasts longer than To, then it will go to step 340. In step 340, based on user's setting or design, any combination of high pitch sound, remind sound or chemical vapor will be emitted.

FIG. 4 shows another exemplary method of determining and reacting on mosquitoes' presence. In step 410, utilizing a microphone to receive surrounding sounds. In step 420, utilizing a filter to filter out unwanted frequency of the received surrounding sounds, which are unrelated to the frequencies of female mosquitoes flapping their wings, to generate filtered sounds. In step 430, utilizing a processor to examine the filtered sounds if the filtered sound profile meets any of pre-stored mosquito sound profiles. If the filtered sound profile does not meet any of the pre-stored mosquito sound profiles, it will go back to step 410 and starts to receive surrounding sound again. However, if the filtered sound meets any of the pre-stored mosquito sound profiles, then it will go to step 440. In step 440, based on user's setting or design, any combination of high pitch sound, remind sound or chemical vapor will be emitted.

The method shown in the flow chart of FIG. 3 can be used in a standalone device as shown in FIG. 1-1, FIG. 1-2, and FIG. 1-3. The method shown in the flow chart of FIG. 3 can also be used in an existing portable device, such as a smart watch or a smart phone. Many smart watches or smart phones have an existing microphone to receive surrounding sound, a processor to operate the instructions, battery to supply power and speaker to emit high pitch sound. If the speaker is not capable for emitting high pitch sound, designer can install another high pitch speaker into the smart watch or smart phone. Designer can also add another component, such as band-pass filter if current component cannot perform such function.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A mosquito repelling device, comprising:
a microphone, configured to receive surrounding sounds;
a power supply, configured to receive power;
a first output device, configured to repel mosquitoes; and
a processor, configured to process the received surrounding sounds from the microphone, determine whether there are mosquitoes present, and instruct the output device to repel mosquitoes if the processor determines there are mosquitoes present.

2. The mosquito repelling device of claim 1, wherein the processor further comprises:
a band-pass filter, configured to filter out frequencies, which are unrelated to the frequencies of female mosquitoes flapping their wings.

3. The mosquito repelling device of claim 2, wherein the processor determines whether there are mosquitoes present by comparing the filtered sounds against a pre-stored mosquito sound profile.

4. The mosquito repelling device of claim 2, wherein the processor determines whether there are mosquitoes present by checking if a magnitude of the filtered sounds is greater than a threshold for a period of time.

5. The mosquito repelling device of claim 1, wherein the first output device is a high pitch sound speaker.

6. The mosquito repelling device of claim 1, wherein the first output device is a chemical vapor emitter.

7. The mosquito repelling device of claim 1, wherein the mosquito repelling device further comprises a second output device.

8. The mosquito repelling device of claim 8, wherein the second output device is a LED, configured to indicate a status of the first output device.

9. The mosquito repelling device of claim 8, wherein the second output device is a speaker, configured to indicate a status of the first output device.

10. The mosquito repelling device of claim 1, further comprising:
a display; and
a control interface, configured to provide a user setting of the mosquito repelling device on the display.

11. The mosquito repelling device of claim 1, wherein the processor further comprises a power management module, configured to manage a power consumption of the first output device.

12. A method of determining and reacting on a presence of a mosquito, comprising:
utilizing a microphone to receive surrounding sounds;
utilizing a filter to filter out frequencies in the surrounding sounds, which are unrelated to the frequencies of female mosquitoes flapping their wings, to generate filtered sounds;
utilizing a processor to examine the filter sounds in order to determine the presence of the mosquito; and
emitting a mosquitoes repelling item.

13. The method of claim 13, wherein the step of utilizing the processor to examine the filter sounds in order to determine the presence of the mosquito comprises:
examining whether a magnitude of the filtered sounds is greater than a threshold for a certain period of time.

14. The method of claim 13, wherein the step of utilizing the processor to examine the filter sounds in order to determine the presence of the mosquito comprises:
examining whether the filtered sounds meet a pre-stored mosquito sound profile.

15. The method of claim 13, wherein the repelling item is a high pitch sound.

16. The method of claim 13, wherein the repelling item is chemical vapor.

17. The method of claim 13, being applicable in a mosquito repelling device.

18. The method of claim 17, wherein the mosquito repelling device is a smart watch or a smart phone.
